(19) United States
(12) Patent Application Publication
(10) Pub. No.: US 2025/0178767 A1
(43) Pub. Date: Jun. 5, 2025

(54) DRUG FEEDER AND TABLET PACKING MACHINE

(71) Applicant: TOSHO, INC., Tokyo (JP)

(72) Inventors: Yoshihito OMURA, Tokyo (JP); Shunji OHGAYA, Tokyo (JP)

(73) Assignee: TOSHO, INC., Tokyo (JP)

(21) Appl. No.: 18/842,749

(22) PCT Filed: Jan. 19, 2023
(86) PCT No.: PCT/JP2023/001550

§ 371 Date: Aug. 29, 2024

(30) Foreign Application Priority Data
Mar. 25, 2022 (JP) 2022-050550

(51) Int. Cl. B65B 37/08; B65B 1/10

(52) U.S. Cl. CPC B65B 37/08; B65B 1/10

(57) ABSTRACT

A drug feeder capable of discharging tablets in a reduced time while preventing simultaneous discharge of multiple tablets is provided. The drug feeder includes an annular rotating body rotatable about a first axis of rotation; an inclined rotating body rotatable about a second axis of rotation inclined relative to the first axis of rotation, the inclined rotating body being disposed inside the annular rotating body; a sorting member and a regulating member that align solid drugs when the annular rotating body rotates, the drugs being carried to a top peripheral portion of the annular rotating body by rotation of the inclined rotating body; and drug drop detection means that detects the drugs carried to a drop discharge port by the annular rotating body and dropped. The sorting member is disposed to regulate a height for the drugs on the top peripheral portion of the annular rotating body. The regulating member regulates a lateral width of a drug conveying path on the top peripheral portion of the annular rotating body. The drug feeder further comprises a path extending member capable of being disposed along the top peripheral portion of the annular rotating body in a vicinity of the drop discharge port and on an outer peripheral side of the annular rotating body, thereby defining a side wall of the drug conveying path. The path extending member serves to extend the drug conveying path.

### TECHNICAL FIELD

The present invention relates to a drug feeder for automatically supplying solid drugs, such as tablets or ampoules, for automatic medicine dispensation at hospitals, pharmacies, etc., and to a tablet packing machine including the drug feeder.

### BACKGROUND ART

An example of a known drug feeder includes an upper container unit (driven unit) containing drugs and a lower base unit (driving unit) to which the drugs are successively discharged from the container unit.

Drug feeders employing removably attachable drug cassettes as the container unit (see, for example, PTL 1) are limited in the variety of drugs that can be handled, but are widely used because of the convenience of attachment/removal of the cassettes.

In contrast, drug feeders in which the container unit and the base are combined are becoming more popular because of their convenience in handling various types of drugs.

An example of such a drug feeder includes two rotating bodies: an inner rotating body and an outer rotating body. Drugs are individually aligned on a top peripheral portion of the outer rotating body, and are guided to and discharged from a discharge port one at a time (see, for example, PTLs 2 and 3). Another known drug feeder includes a mechanism capable of changing a width and a height of a drug conveying path in accordance with the dimension of the drugs to align the drugs individually.

### CITATION LIST

### Patent Literature

PTL 1: Japanese Unexamined Patent Application Publication No. 2013-146443

PTL 2: Japanese Unexamined Patent Application Publication No. 2018-108277

PTL 3: Japanese Patent No. 6736075

PTL 4: Japanese Unexamined Patent Application Publication No. 2021-115382

PTL 5: Japanese Unexamined Patent Application Publication No. 2021-126254

These drug feeders are advantageous in that a single drug feeder can handle multiple types of drugs. However, it has also been known that, depending on the size of the drugs, multiple drugs may be arranged side by side on the drug conveying path, causing simultaneous discharge of multiple drugs, or conversely, prolonging the time until the discharge.

To solve the above-described problem, for example, the rotational speeds of the rotating bodies may be changed to reduce the time until the discharge. However, there are limits to increasing the rotational speeds while maintaining the convenience of handing various types of tablets, and it has been a technical challenge to increase the discharge rate and the reliability of discharge at the same time.

### SUMMARY OF INVENTION

### Technical Problem

To solve the above-described technical problem, an object of the present invention is to provide a drug feeder capable of reliably discharging tablets one at a time at an increased discharge rate.

### Solution to Problem

To solve the above-described technical problem, a drug feeder according to the present invention includes an annular rotating body rotatable about a first axis of rotation; an inclined rotating body rotatable about a second axis of rotation inclined relative to the first axis of rotation, the inclined rotating body being disposed inside the annular rotating body; a sorting member and a regulating member that align solid drugs when the annular rotating body rotates, the drugs being carried to a top peripheral portion of the annular rotating body by rotation of the inclined rotating body; and drug drop detection means that detects the drugs carried to a drop discharge port by the annular rotating body and dropped. The sorting member is disposed to regulate a height for the drugs on the top peripheral portion of the annular rotating body. The regulating member regulates a lateral width of a drug conveying path on the top peripheral portion of the annular rotating body. The drug feeder further comprises a path extending member capable of being disposed along the top peripheral portion of the annular rotating body in a vicinity of the drop discharge port and on an outer peripheral side of the annular rotating body, thereby defining a side wall of the drug conveying path. The path extending member serves to extend the drug conveying path.

### Advantageous Effects of Invention

According to the present invention, tablets can be reliably discharged one at a time at an increased discharge rate.

### BRIEF DESCRIPTION OF DRAWINGS

FIG. 1 illustrates an example of the structure of a tablet packing machine according to an embodiment of the present invention.

FIG. 2 illustrates an example of the structure of a drug feeder according to the present invention.

FIG. 3 illustrates an example of the structure of an inclined rotating body included in the drug feeder.

FIG. 4 illustrates the structure of FIG. 3 viewed in a direction of a central projection.

FIG. 5 illustrates an example of the structure of an annular rotating body.

FIG. 6 is an external perspective view illustrating an example of the structure of the drug feeder according to the present embodiment.

FIG. 7 is a top view illustrating an example of the structure of a regulation mechanism and a sorting unit included in the drug feeder.

FIG. 8 illustrates an aligning operation of the drug feeder.

FIG. 9 illustrates an example of an unfavorable situation caused during high-speed rotation of the drug feeder.

FIG. 10 illustrates an example other than FIG. 9.

FIG. 11 illustrates another example other than FIG. 9.

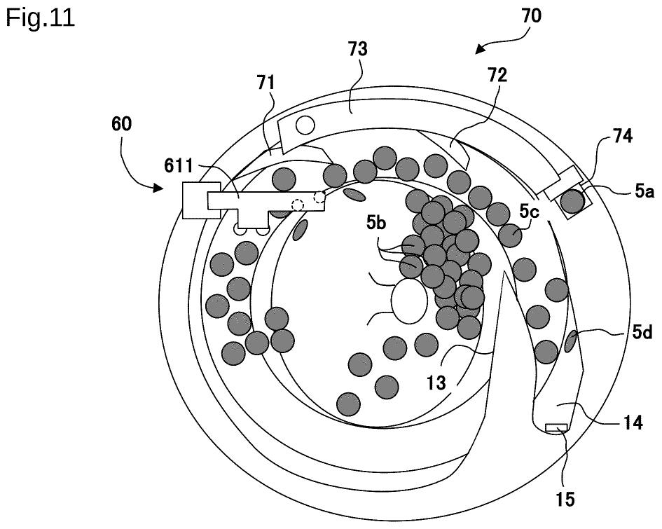

FIG. 12 illustrates reverse rotation of the drug feeder.

FIG. 13 illustrates an example of the structure of a path extending member according to the present invention.

FIG. 14 is a perspective view illustrating the structure of a part of the path extending member.

FIG. 15 illustrates an example of the structure in which the path extending member according to the present invention is attached.

FIG. 16 illustrates an example of the effects of the path extending member in the unfavorable situation illustrated in FIG. 10.

FIG. 17 illustrates an example of an operation of the path extending member in accordance with the dimension of drugs.

FIG. 18 illustrates an example of an operation of the path extending member in accordance with the dimension of the drugs.

FIG. 19 illustrates an example of a path along which a drug moves when no path extending member is provided.

FIG. 20 illustrates an example of the effects provided when the path extending member is attached.

FIG. 21 illustrates another shape of the path extending member as a modification.

### DESCRIPTION OF EMBODIMENTS

### First Embodiment

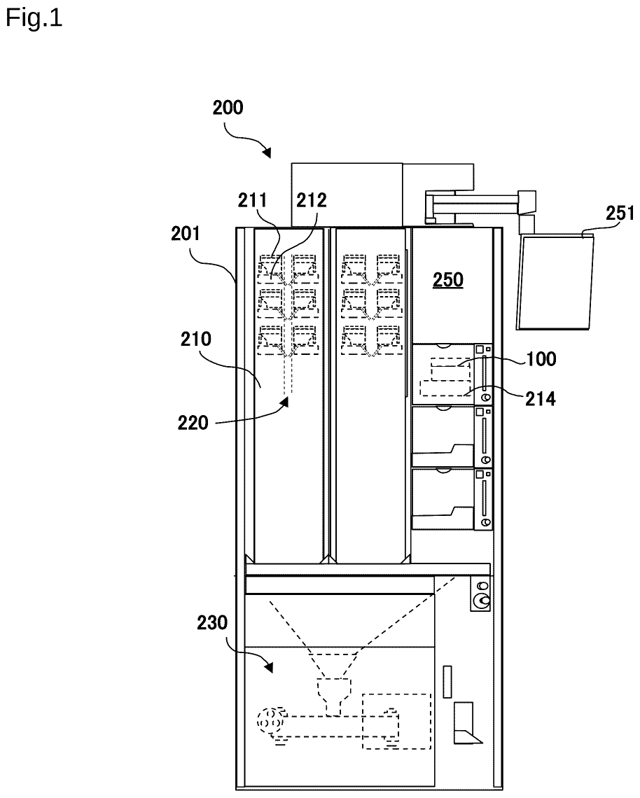

FIG. 1 illustrates a drug feeder 100 and a tablet packing machine 200 including the drug feeder 100 as a first embodiment of the present invention.

The tablet packing machine 200 includes a housing 201 having an upper section in which a plurality of drug storage boxes 210 are installed such that the drug storage boxes 210 can be drawn out individually. Each drug storage box 210 accommodates drug cassettes 211 and base units 212 that are paired and arranged vertically and horizontally. A drug feeder 100 is also provided in the upper section of the housing 201. A packing unit 230 is accommodated in a lower section of the housing 201. A control unit 250, which is a control device, is placed in a space for electrical equipment in the housing 201.

The tablet packing machine 200 includes the packing unit 230 and a tablet drop path 220. The packing unit 230 packs tablets discharged from the drug cassettes 211 or the drug feeder 100 individually or in groups of two or more with packing paper. The tablet drop path 220 connects the packing unit 230 to the drug cassettes 211 and the drug feeder 100.

The tablet packing machine 200 includes a touch panel 251, which is an operation unit connected to the control unit 250 and used by an operator to operate the tablet packing machine 200. The touch panel 251 also functions as a display unit that displays information received from the control unit 250, for example, information regarding the lack of tablets and the operating status of the tablet packing machine 200.

Each drug cassette 211, which is removably attachable, stores many drugs of one type among various types of drugs, and successively discharges the drugs one at a time in response to an instruction from the control unit 250.

Each base unit 212 is a fixed unit to which one of the drug cassettes 211 can be removably attached. The drug cassettes 211 attached to the base units 212 are driven to discharge drugs 5.

The drugs 5 discharged from the drug cassettes 211 fall through the tablet drop path 220 provided in the drug storage box 210 and reach the packing unit 230.

The drug cassettes 211, the packing unit 230, the tablet drop path 220, and other components have structures similar to those in a tablet packing machine according to the related art. The drug feeder 100 may, for example, be applied to a tablet packing machine having a structure other than the structure described in the present embodiment. The overall arrangement of the members, for example, may be similar to known arrangements, and detailed description thereof is thus omitted.

The tablet packing machine 200 performs a so-called packing operation in which the drugs 5 are discharged and packed individually or in groups of two or more with packing paper by using the drug cassettes 211, the packing unit 230, and the tablet drop path 220. The packing operation may be similar to those described in, for example, PTLs 4 and 5, and description thereof is thus omitted.

For convenience of description, in the present embodiment, the drug feeder 100 is disposed in a drawer at a location separate from the drug storage boxes 210 in the housing 201 in FIG. 1. However, the drug feeder 100 is not limited to this, and may be disposed at any location in the tablet packing machine 200.

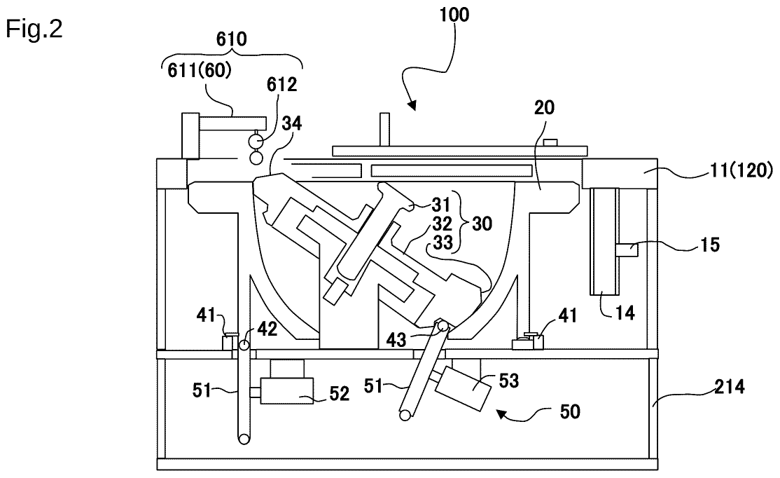

As illustrated in FIG. 2, the drug feeder 100 is a double-rotation feeder in which a container unit and a lower structure 214 are integrated and that is mounted in the tablet packing machine 200. The drug feeder 100 is driven by a drive mechanism 213 of the lower structure 214. The lower structure 214 may have a shape that is the same as or different from the shape of the base unit 212 corresponding to each drug cassette 211. In either case, the drug feeder 100 is integrated with the base unit, and the integrated structure is securely installed in any section of any drug storage box 210 or the tablet packing machine 200. In the present embodiment, the drug feeder 100 is integrated with the lower structure 214, which serves as a base unit. However, the drug feeder 100 is not limited to this, and may be removably attachable to the base unit 212, similarly to each drug cassette 211.

The drug feeder 100 includes a peripheral wall 11, an annular rotating body 20, an inclined rotating body 30, a support mechanism 40, a rotary drive mechanism 50, a sorting unit 60, and a regulation mechanism 70. The peripheral wall 11 is positioned in an upper region and has a circular hollow opening at the center. The annular rotating body 20 is disposed such that a top portion thereof is loosely fitted to the hollow opening in the peripheral wall 11, or is disposed directly below the hollow opening in the peripheral wall 11. The inclined rotating body 30 disposed in a hollow space in the annular rotating body 20. The support mechanism 40 supports the inclined rotating body 30 in an inner region and the annular rotating body 20 outside the inclined rotating body 30 such that the inclined rotating body 30 and the annular rotating body 20 are rotatable about axes thereof. The rotary drive mechanism 50 rotates the inclined rotating body 30 and the annular rotating body 20. The sorting unit 60 and the regulation mechanism 70 are provided above the peripheral wall 11.

The support mechanism 40 maintains the annular rotating body 20 rotatable about a predetermined axis, which is a straight line O1 herein, and maintains the inclined rotating body 30 rotatable about an inclined line O2 that is inclined relative to the straight line O1. The straight line O1 may be vertical. However, in the present embodiment, although not illustrated, the straight line O1 is inclined about 3.5°, for example, so as not to impair the drug conveying function.

The inclined rotating body 30 in the inner region and the annular rotating body 20 in the outer region form a rotating container of a double-rotation drug feeder in which the inclined rotating body 30 blocks the hollow space in the annular rotating body 20 with a small gap therebetween that allows the rotation but does not allow the passage of the drugs.

As described below, the inclined rotating body 30 is preferably disposed inside the annular rotating body 20 such that at least a portion of an outer periphery of the inclined rotating body 30 is positioned above a top peripheral portion 23, which is an upper surface of the annular rotating body 20. With this structure, the drugs 5 placed in the rotating container are moved upward by the inclined rotating body 30, as described below, and transferred to the top peripheral portion 23.

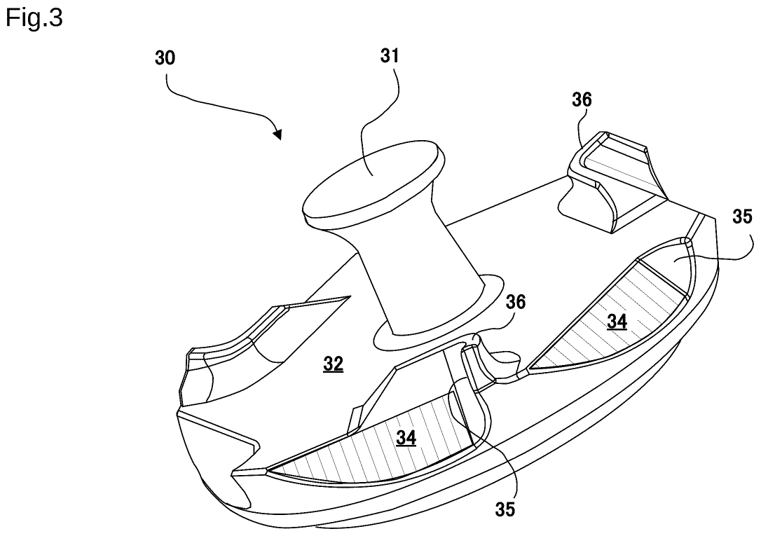

As illustrated in FIG. 3, the inclined rotating body 30 includes a central projection 31, a central portion 32, and a peripheral portion 33. When the inclined rotating body 30 is disposed to occupy the inner space of the annular rotating body 20, the upper surface of the inclined rotating body 30 serves as the inner bottom of the rotating container.

The central projection 31 is formed at the center of the upper surface of the inclined rotating body 30. The annular rotating body 20 and the inclined rotating body 30 can be lifted together by holding central projection 31.

The central portion 32, which is the upper surface around the central projection 31, is approximately flat. In this example, the central portion 32 is formed to be approximately flat to increase the strength and workability, for example. However, the central portion 32 may be recessed from the peripheral portion 33. In such a case, the internal space of the rotating container can be increased.

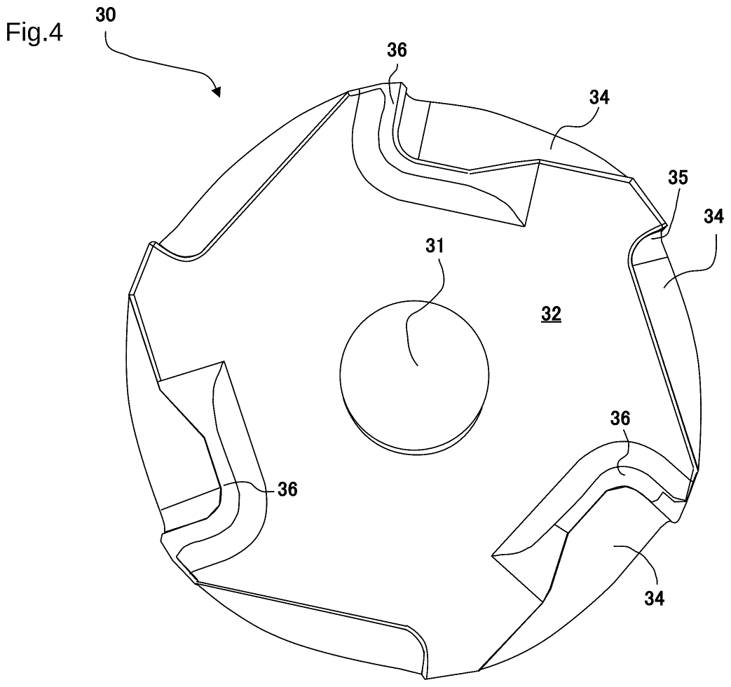

As illustrated in FIG. 4, the peripheral portion 33 at the outer periphery of the upper surface of the central portion 32 includes delivery portions 34 and push-up portions 35. In the present embodiment, the delivery portions 34 and the push-up portions 35 are alternately arranged in the circumferential direction.

The delivery portions 34 are outwardly falling local notches having a chamfered shape that are larger than the drugs 5 to be handled. The angle of the outward falling notches is about 45°, and is greater than the inclination angle of the inclined rotating body 30 in the mounted state, which is about 20° to 30°.

As illustrated in FIG. 2, the delivery portions 34 are inclined such that, when the inclined rotating body 30 is disposed inside the annular rotating body 20, the delivery portions 34 are inclined outward and downward even at the uppermost position at which the outward and downward inclination is minimum. In other words, the outward inclination of the delivery portions 34 is greater than the difference in inclination between the inclined line O2 and the vertical line O1.

Therefore, when the inclined rotating body 30 is mounted in the annular rotating body 20 in the inclined state and rotated about the axis, the outward and downward inclination angle of the delivery portions 34 is maintained at or above approximately 15° at the raised position at which the delivery portions 34 are closest to horizontal (that is, the position at which the inclination relative to the horizontal surface is expected to be minimum). Each delivery portion 34 has many shallow straight grooves extending approximately radially and arranged parallel to each other. This structure allows the drugs 5 to easily roll along the inclined surfaces, so that the drugs 5 can be effectively stirred and easily guided to the top peripheral portion 23.

The push-up portions 35 are uprising portions positioned at the trailing ends of the delivery portions 34 in the circumferential direction. Unlike the delivery portions 34, the push-up portions 35 are not inclined outward and downward, but extend upward from the delivery portions 34 to or beyond the central portion 32.

The push-up portions 35 move the drugs 5 placed in the central portion 32 upward with the uprising surfaces thereof. Also, when the inclined rotating body 30 is mounted in the inclined state as illustrated in FIG. 2, the push-up portions 35 pass the drugs 5 to the delivery portions 34 to facilitate the movement of the drugs 5 to the top peripheral portion 23.

Every other one of the delivery portions 34 arranged in the circumferential direction is provided with a projection 36 that projects upward from the central portion 32 at the boundary between the delivery portion 34 and the central portion 32. Each projection 36 moves the drugs 5 upward. Since a surface of the projection 36 facing the delivery portion 34 is recessed, the drugs 5 that have been moved upward are retained by the surface of the projection 36 facing the delivery portion 34 and easily transferred from the delivery portion 34 to the top peripheral portion 23 at the uppermost position.

The inclined rotating body 30 rotates to raise the drugs 5, and the sorting unit 60 sorts the drugs 5, so that the drugs 5 are conveyed from the peripheral portion 33 of the inclined rotating body 30 to the top peripheral portion 23 of the annular rotating body 20. The annular rotating body 20 rotates to convey the drugs 5 horizontally, and the regulation mechanism 70 aligns the drugs 5, so that the drugs 5 on the top peripheral portion 23 are aligned and conveyed to the drop discharge port 14.

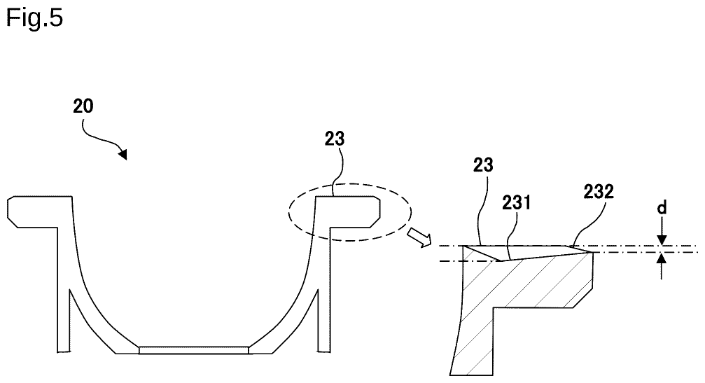

As illustrated in FIG. 5, the annular rotating body 20 is a bowl-shaped member with an open bottom.

In the present embodiment, the diameter of the hollow space in the annular rotating body 20 is largest at the uppermost position at which the top peripheral portion 23 is disposed, and decreases toward the bottom.

Therefore, the inclined rotating body 30 can be freely placed into and removed from the hollow space in the annular rotating body 20, and the components can be easily assembled and replaced.

The annular rotating body 20 includes the flange-shaped top peripheral portion 23 along the edge at the top thereof. As illustrated in the enlarged view in FIG. 5, the top peripheral portion 23 has a chamfer 232 inclined downward at about 7° along the entire circumference of the outer periphery thereof. With this structure, the drugs 5 are expected to smoothly slide into the drop discharge port 14 when the drugs 5 are conveyed to the drop discharge port 14 as described below.

The annular rotating body 20 and the inclined rotating body 30 may, for example, be inseparably attached to each other with a magnet or a fixing tool, such as a bolt, such that only rotations thereof are allowed. When the annular rotating body 20 and the inclined rotating body 30 constitute an inseparable unit, they may be referred to as a rotating container 20+30.

In the present embodiment, the top peripheral portion 23 has may grooves 231 arranged at equal pitch in the circumferential direction. Each groove 231 is a cut having a shape close to a rhomboidal or spindle shape, and has a longitudinal direction extending in the radial direction. The width of each groove 231 is reduced at both ends in the radial direction and increased at an intermediate position in the radial direction, so that the drugs can easily settle at the widened portion. The deepest portion of each groove 231 has a depth e greater than a depth d of the chamfer 232. In the present embodiment, an outer end portion of each groove 231 in the radial direction extends to the portion at which the chamfer 232 is formed. Therefore, the drugs smoothly move from the grooves 231 to the chamfer 232.

The grooves 231 and the chamfer 232 have smooth surfaces so as not to impede the movement of the drugs 5. However, in the regions excluding the groove 231 and the chamfer 232, the upper surface of the top peripheral portion 23 is preferably a rough surface formed by, for example, blasting to prevent slipping of the drugs 5.

The support mechanism 40 is composed of a plurality of members dispersed at different locations and including several bearing members 41 composed mainly of, for example, radial bearings, and rotation transmission members 42 and 43 composed of ring-shaped or loop-shaped bodies, such as hard rubber O-rings. The support mechanism 40 is not limited to this structure, and may have any structure as long as the support mechanism 40 is disposed in the lower structure 214, supports the annular rotating body 20 and the inclined rotating body 30, and transmits rotational driving force.

Each bearing member 41 includes a rotating body having an outer peripheral surface in contact with an outer peripheral surface or a lower surface of the annular rotating body 20 or with a lower surface of the inclined rotating body 30. The bearing members 41 are provided exclusively for holding the annular rotating body 20 and the inclined rotating body 30 at fixed positions in an easily rotatable state.

The rotation transmission members 42 and 43 are attached to respective rotary drive members 51 described below, and have a rotation transmission function. The rotation transmission members 42 and 43 also function as supporting members by supporting and holding the annular rotating body 20 and the inclined rotating body 30 at the fixed positions in an easily rotatable state together with the bearing members 41.

Each of the bearing members 41 and the rotation transmission members 42 and 43 is disposed to be in contact with the lower surface or the outer peripheral surface of the annular rotating body 20 or the inclined rotating body 30. Therefore, the rotating container 20+30, constituted by the annular rotating body 20 and the inclined rotating body 30, can be appropriately attached to the support mechanism 40 by placing the rotating container 20+30 onto the bearing members 41 and the rotation transmission members 42 and 43 from above. The rotating container 20+30 can also be easily removed by lifting the rotating container 20+30.

The rotary drive mechanism 50 includes an annular-rotating-body drive motor 52, an inclined-rotating-body drive motor 53, and the disc-shaped rotation transmission members 51 attached to drive shafts of the annular-rotating-body drive motor 52 and the inclined-rotating-body drive motor 53, all of which are disposed below the rotating container 20+30. The above-described rotation transmission members 42 and 43 of the support mechanism 40 not only support the rotating container 20+30 but also transmit the rotational driving force, and therefore also function as parts of the rotary drive mechanism 50.

More specifically, the rotation transmission member 42 contacts the annular rotating body 20 and performs the rotation transmission function by frictional transmission when driven by the annular-rotating-body drive motor 52.

The rotation transmission member 43 contacts the inclined rotating body 30 and performs the rotation transmission function by frictional transmission when driven by the inclined-rotating-body drive motor 53.

The rotary drive mechanism 50 causes the rotary drive motor 52 to rotate the annular rotating body 20 about the axis at a relatively high speed, and causes the rotary drive motor 53 to rotate the inclined rotating body 30 about the axis at a relatively low speed.

In the present embodiment, two different motors are used to drive the annular rotating body 20 and the inclined rotating body 30 individually. However, the structure is not limited to this. A rotation transmission member 51 having a trapezoidal shape may be attached to a drive shaft of a single motor. A large-diameter portion may serve as the rotation transmission member 42 that contacts and transmits driving force to the annular rotating body 20, and a small-diameter portion may serve as the rotation transmission member 43 that contacts and transmits driving force to the inclined rotating body 30.

Due to the difference in diameter, even when a single motor is used, the annular rotating body 20 and the inclined rotating body 30 can be rotated at different speeds to maintain the effect of aligning the drugs 5 on the top peripheral portion 23 as described below.

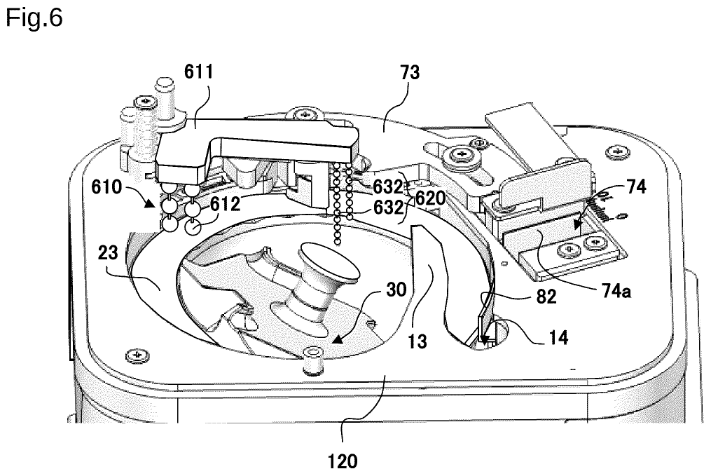

As illustrated in FIG. 6, in the present embodiment, the sorting unit 60 includes a first sorting member 610 and a second sorting member 620. The first sorting member 610 is disposed upstream of the regulation mechanism 70 along a drug conveying path on the top peripheral portion 23 of the annular rotating body 20. The second sorting member 620 is disposed next to the regulation mechanism 70 along the drug conveying path.

The first sorting member 610 and the second sorting member 620 are attached to a support member 611, which is attached to a plate 120 that includes a discharge guide 13 and supports the regulation mechanism 70.

In other words, the sorting unit 60 includes the support member 611 that is vertically movable by a screw mechanism; the first sorting member 610 attached to an upstream portion of the support member 611 in a conveying direction and vertically movable together with the support member 611; and the second sorting member 620 attached to a downstream portion of the support member 611 in the conveying direction and vertically movable together with the support member 611.

According to the above-described structure, the sorting unit 60 is configured such that the screw mechanism is rotated by driving a motor through a controller to move the support member 611 vertically. Therefore, the vertical positions of the lower ends of the first sorting member 610 and the second sorting member 620 can be automatically adjusted together. This is preferably performed automatically based on an instruction from the control unit 250. However, the vertical positions may, for example, be adjusted by a manual screw mechanism or by an operator based on visual observation.

In the present embodiment, the first sorting member 610 includes a plurality of front suspended objects 612, each of which is formed by loosely connecting objects (three spheres in the illustrated example) into a chain shape, and can be easily prepared at low cost when a commercially available ball chain, for example, can be used.

The first sorting member 610 includes three front suspended objects 612 that are arranged side by side and hang from the support member 611 above the drug conveying path on the top peripheral portion 23. In a normal state, the vertical positions of the front suspended objects 612 are adjusted such that the lower ends thereof are slightly above the drugs.

The second sorting member 620 includes a middle suspended object 622 and a rear suspended object 632 that are attached to a distal end portion of the support member 611 and move vertically together with the support member 621.

Similarly to the first sorting member 610, each of the middle suspended object 622 and the rear suspended object 632 is formed by loosely connecting a plurality of spherical objects. However, the spherical objects are smaller in size and greater in number compared to those of the front suspended objects 612.

The spherical objects of the middle suspended object 622 and the spherical objects of the rear suspended object 632 may differ in diameter or number. In addition, the shapes of the objects are not limited to spheres.

The sorting unit 60 is capable of preventing the drugs 5 from being stacked on the drug conveying path by gently pushing the drugs 5 in reaction to the drugs 5 coming into contact therewith.

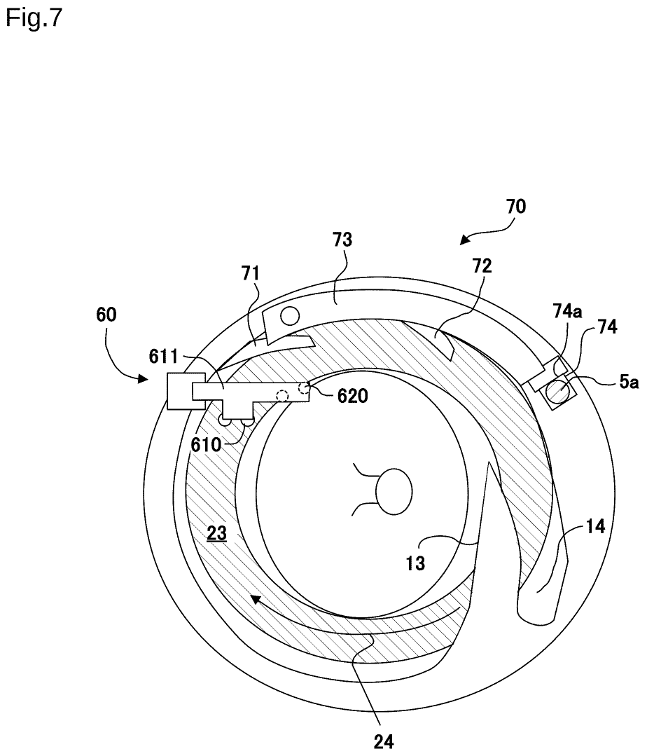

As illustrated in FIG. 7, the regulation mechanism 70 includes a first regulating member 71, a second regulating member 72, a link mechanism 73, and a model receiver 74. The first regulating member 71 is disposed in front of the sorting unit 60 in a rotation direction 24 of the top peripheral portion 23 of the annular rotating body 20. The second regulating member 72 is disposed in front of the first regulating member 71 in the rotation direction 24. The link mechanism 73 is connected to each of the first regulating member 71 and the second regulating member 72 with, for example, a pin-shaped rotation-allowing shaft member. The model receiver 74 is capable of receiving the drugs 5.

Each of the first regulating member 71 and the second regulating member 72 has a swing center on the peripheral wall 11 and a swing end portion positioned above the top peripheral portion 23 of the annular rotating body 20, and is therefore capable of narrowing the drug conveying path on the top peripheral portion 23 from the outer periphery.

At least one of multiple wall surfaces defining the model receiver 74 is operable in conjunction with a link mechanism 73. By manually moving a movable wall 74a to match an interval between side walls of the model receiver 74 with the dimension of a sample drug 5a, the regulation mechanism 70 can be operated in accordance with the width of the sample drug 5a placed on the model receiver 74.

The first regulating member 71 and the second regulating member 72 swing simultaneously and similarly in response to a movement of the link mechanism 73 in a longitudinal direction. Thus, the amount of adjustment by which the drug conveying path is narrowed corresponds to the width of the sample drug 5a placed on the model receiver 74.

More specifically, after the sample drug 5a is placed on the model receiver 74, the link mechanism 73 is moved forward in the longitudinal direction of the model receiver 74 and stopped when an end thereof comes into contact with the sample drug 5a. The swing end portion of the first regulating member 71 and the swing end portion of the second regulating member 72 are connected with the link mechanism 73. Therefore, each of the swing end portions reduce the width of the drug conveying path on the top peripheral portion 23 to a width corresponding to the width of a single drug based on the sample drug 5a.

As described above, the model receiver 74 and the link mechanism 73 serve as a dimension measurement mechanism that measures the dimension at a predetermined position of the sample drug 5a placed on the model receiver 74. The dimension at the “predetermined position” may be, for example, the diameter, width, length, or thickness of the sample drug 5a. When the sample drug 5a is a so-called round tablet, the diameter is preferred. The position can be determined when the operator places the sample drug 5a on the model receiver 74. Therefore, the operator preferably sets the most appropriate position based on the shape of the drugs 5 conveyed along the top peripheral portion 23.

Alternatively, the amount of adjustment by which the drug conveying path is narrowed may be automatically set based on dimension data received from a host device, such as a dispensation server, and the regulation mechanism 70 may be automatically adjusted to a position corresponding to the predetermined dimension.

The peripheral wall 11 has the drop discharge port 14 that vertically extends therethrough at a position downstream of the regulation mechanism 70 in the rotation direction of the annular rotating body 20.

The discharge guide 13 is disposed upstream of the drop discharge port 14 in the rotation direction and downstream of the regulation mechanism 70 in the rotation direction. The discharge guide 13 extends above the top peripheral portion 23 so as to obliquely cross the top peripheral portion 23.

The discharge guide 13 extends from the peripheral wall 11 at a position behind the drop discharge port 14 and extends above the top peripheral portion 23 such that an end portion thereof projects into a region above the peripheral portion 33 of the inclined rotating body 30. Therefore, when the drugs 5 conveyed by the top peripheral portion 23 of the annular rotating body 20 move in the rotation direction, the drugs 5 come into contact with a side wall of the discharge guide 13 at an oblique angle, move obliquely along the side wall as the annular rotating body 20 rotates, and are guided gradually toward the outer periphery. Finally, the drugs 5 reaches the drop discharge port 14.

The end portion of the discharge guide 13 includes a conveying surface guide 12 extending downward and forward to define the foremost end. The conveying surface guide 12 has an upper surface at substantially the same height as the top peripheral portion 23 of the annular rotating body 20, and is positioned on the inner peripheral side of the top peripheral portion 23. Thus, when the drugs carried by the top peripheral portion 23 of the annular rotating body 20 come into contact with the discharge guide 13, undesirable situations, such as the drugs falling toward the inclined rotating body 30 in reaction to the contact or being caught between the annular rotating body 20 and the discharge guide 13, can be sassily prevented.

The above-described structure is provided by the shape of the plate 120, which is an upper member attached to the top of the annular rotating body 20. The space surrounded by the discharge guide 13 and the peripheral wall 11 of the plate 120 and the top peripheral portion 23 serves as the drug conveying path along which the drugs are conveyed by the rotation of the annular rotating body 20.

Although not illustrated, a controller that controls the operation of the rotary drive motors 52 and 53 and a power supply that supplies operating power to the rotary drive motors 52 and 53 are also provided inside or outside the housing.

The drop discharge port 14 is provided with a photosensor 15 that serves as drug drop detection means for detecting the drugs 5 conveyed to and dropped from the drop discharge port 14. A detection signal obtained by the photosensor 15 is transmitted to the controller or a tablet counter.

The controller initially controls the rotation at a low speed. After the discharge of the first drug is detected and then the discharge of a preset number of drugs 5 is detected, the rotational speed is changed to a high speed. The controller also calculates the number of remaining drugs based on a predetermined total number and the number of drugs that have been discharged. When the number of remaining drugs is reduced to a predetermined number, the controller reduces the rotational speed or reverses the rotation to prevent undesirable dropping of excessive drugs after the completion of discharging of the drugs.

The operation of introducing the drugs 5 into the drug feeder 100 having the above-described structure and successively discharging the drugs 5 will now be described with reference to the drawings.

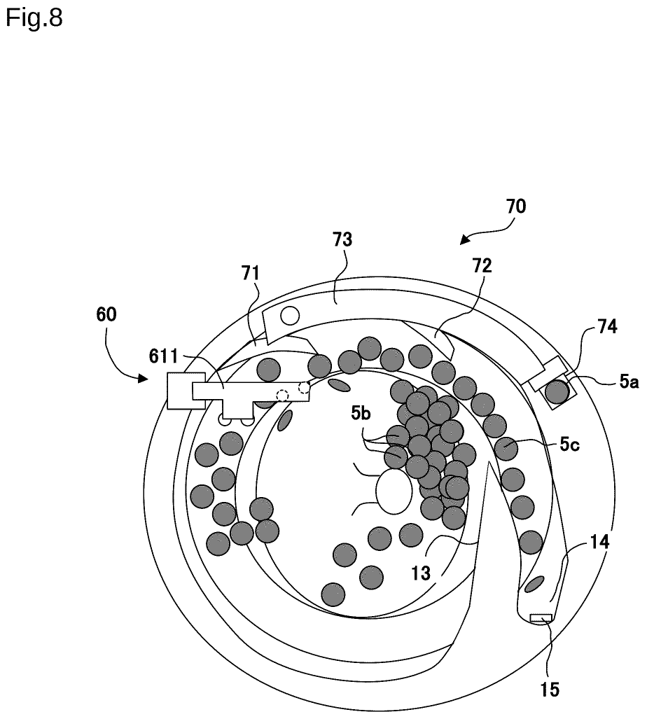

FIGS. 7 to 9 are schematic diagrams illustrating the structure at the start of an operation of aligning the drugs 5 contained in the rotating container 20+30 on the top peripheral portion 23. The drugs 5 described herein are assumed to have the same shape, but may be referred to as the sample drug 5a, randomly contained drugs 5b, or aligned drugs 5c depending on the situation thereof.

To successively feed many drugs 5 by using the drug feeder 100, first, the regulation of the width of the drug conveying path by the regulation mechanism 70 and the random introduction of the drugs 5 are completed.

As described above, in the operation of regulating the width of the drug conveying path, the operator selects an appropriate one of the drugs 5 as the sample drug 5a, places the sample drug 5a on the model receiver 74 in a desired manner, and adjusts the position of the link mechanism 73 so that one end of the link mechanism 73 comes into contact with the sample drug 5a.

When the regulating operation is carried out, the first regulating member 71 and the second regulating member 72 both swing in conjunction with the link mechanism 73, so that the swing end portions thereof reduce the width of the drug conveying path on the top peripheral portion 23 of the annular rotating body 20 to a width corresponding to the diameter of the sample drug 5a at two locations.

The random introduction of the drugs 5 may be performed by the operator by randomly introducing many drugs 5 into the rotating container 20+30 through the top opening of the annular rotating body 20. As illustrated in FIG. 7, the randomly contained drugs 5b that have been introduced accumulate on a portion of the upper surface of the inclined rotating body 30 that is at a lower position.

After the above-described preparation operations, the operator operates the touch panel 251 to operate the drug feeder 100 in, for example, a simple continuous feeding mode. After that, the rotary drive motors 52 and 53 rotate at appropriate speeds under the control of the controller based on instructions from the control unit 250.

The rotations of the rotary drive motors 52 and 53 are transmitted to the annular rotating body 20 through the rotation transmission member 42 by frictional transmission and to the inclined rotating body 30 through the rotation transmission member 43 by frictional transmission. Thus, the rotation transmission member 42 and the rotation transmission member 43 rotate about their axes in the same direction. At this time, the controller controls the rotation speeds of the motors so that the annular rotating body 20 rotates at a higher speed than the inclined rotating body 30.

As the inclined rotating body 30 rotates about the axis, the drugs 5 on the peripheral portion 33 of the inclined rotating body 30 among the randomly contained drugs 5b accumulated on the inner bottom of the rotating container 20+30 are moved upward from a lower position to a higher position by the revolution of the peripheral portion 33.

When the drugs 5 are moved to a region in which the peripheral portion 33 is higher than the top peripheral portion 23 of the annular rotating body 20, most of the drugs 5 slide or roll onto the top peripheral portion 23 due to the inclination of the peripheral portion 33.

When the top peripheral portion 23 is packed with previously delivered drugs 5 or when the drugs 5 somehow fail to slide or roll onto the top peripheral portion 23, some of the drugs 5 remain on the peripheral portion 33 of the inclined rotating body 30. These drugs 5 come into contact with the first sorting member 610 or the second sorting member 620 of the sorting unit 60 as the inclined rotating body 30 further rotates about the axis, and are moved away from the top peripheral portion 23 in reaction to the contact. Thus, the drugs 5 slide downward along the inclined surface of the central portion 32 of the inclined rotating body 30.

In this manner, the excess drugs 5, for example, return to the randomly contained drugs 5b, so that the drugs 5 are somewhat regulated and delivered at a nearly optimum frequency to the drug conveying path on the top peripheral portion 23.

Since the annular rotating body 20 rotates about the axis at a higher speed than the inclined rotating body 30, the drugs 5 on the top peripheral portion 23 are somewhat dispersed depending on the difference in rotational speed when the drugs 5 are delivered from the peripheral portion 33.

However, when, for example, the drugs 5 are small, some of the drugs 5 may be arranged along a single longitudinal line, but others may be arranged exactly or obliquely side by side. When these drugs 5 are conveyed to the first regulating member 71 by the axial rotation of the annular rotating body 20, the drugs 5 arranged along a single line simply passes the first regulating member 71. However, the drugs 5 arranged side by side interfere with the first regulating member 71 so that the drugs 5 on the inner side are pushed off from the top peripheral portion 23 and fall onto the inclined rotating body 30, thereby returning to the randomly contained drugs 5b. Thus, the side-by-side arrangement of the drugs 5 is corrected.

However, when, for example, many drugs 5 are arranged side by side, the drugs 5 may push each other, for example, and cannot be dropped only by the first regulating member 71. In such a case, some of the drugs 5 may pass the first regulating member 71 in two lines or a disorderly line. Thus, some of the drugs 5 that have passed the first regulating member 71 may be arranged obliquely side by side.

In any case, the drugs 5 that have passed the first regulating member 71 are conveyed to the second regulating member 72 by the axial rotation of the annular rotating body 20, and are similarly aligned again. Therefore, even when some of the drugs 5 remain side by side, such drugs 5 are rare, and are arranged obliquely and only slightly side by side. Thus, the side-by-side arrangement is quickly and sufficiently corrected when the regulation is performed again.

Thus, the first regulating member 71 and the second regulating member 72 cause the drugs 5 to move along the drug conveying path approximately in one line. The drugs 5 arranged in one line are specifically referred to as aligned drugs 5c.

The aligned drugs 5c that have undergone the two regulation processes as described above and that are arranged in one line are successively conveyed to the discharge guide 13 as the top peripheral portion 23 is revolved by the axial rotation of the annular rotating body 20. Then, the aligned drugs 5c come into contact with an outer side surface of the discharge guide 13 that obliquely crosses the drug conveying path on the top peripheral portion 23.

Many of the aligned drugs 5c immediately move along the contact side surface of the discharge guide 13 and are delivered to the drop discharge port 14 in one line.

There is a possibility that some of the aligned drugs 5c will bounce inward depending on the manner of contact. However, even in such a case, the conveying surface guide 12 formed on the contact surface of the discharge guide 13 that comes into contact with the drugs 5 prevents the aligned drugs 5c from falling into the annular rotating body 20 or being caught in a region in which the top peripheral portion 23 and the discharge guide 13 obliquely intersect.

Thus, all of the aligned drugs 5c are delivered to the drop discharge port 14 in one line without being wasted. The drugs 5 delivered to the drop discharge port 14 fall at an increasing speed due to gravity, so that the intervals between the adjacent drugs 5 increase. Therefore, by detecting the falling drugs 5 with, for example, the photosensor 15 disposed at a position at which the intervals are sufficiently large, the number of drugs 5 can be accurately counted.

An end of the drop discharge port 14 is connected to, for example, the tablet drop path 220. The tablet packing machine 200 causes the packing unit 230 to pack the drugs 5 dropped along the tablet drop path 220 with packing paper, and discharges the packed drugs 5.

When processing of a very large amount of drugs 5 is completed by repeating the alignment and discharge of the drugs 5, or when the type of the drugs 5 is to be changed, it may be necessary to stop the operation of the drug feeder 100 and clean the rotating container 20+30.

In such a case, first, the peripheral wall 11 and other components at the top are removed. Then, the inclined rotating body 30 is raised, for example, by holding the central projection 31 of the inclined rotating body 30, so that the rotating container 20+30 is removed from the housing. The rotating container 20+30 is simply supported by the support mechanism 40, and therefore can be easily removed and cleaned by, for example, washing the rotating container 20+30 as a whole. The rotating container 20+30 can thus be cleaned easily and quickly after use. After that, the above procedure is reversed for reassembly to prepare for the next operation.

In the above-described drug feeder 100, it is desirable to discharge the tablets 5 one at a time at a high speed.

When the tablets are arranged at equal intervals in one line along the tablet conveying path, the discharge rate of the tablets is basically determined by the rotational speed of the annular rotating body 20. It has been known that the discharge rate can be effectively increased by increasing the rotational speed of the annular rotating body 20.

In addition, as described above, the aligned drugs 5c are arranged in one line when conveyed along the tablet conveying path, so that the aligned drugs 5c can be dropped one at a time.

However, experiments conducted by the inventors showed that when the rotational speed of the annular rotating body 20 is simply increased, a new problem arises in that the drugs cannot be easily arranged in one line.

This will now be described in detail.

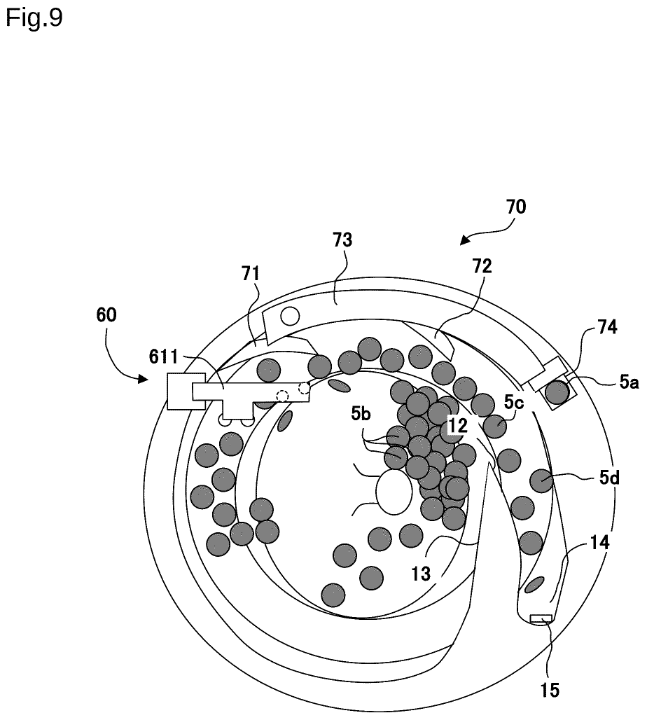

As a comparative example, FIG. 9 illustrates an example in which the rotational speed of the annular rotating body 20 is simply increased.

As is clear from FIG. 9, when the rotational speed is increased, some of the aligned drugs 5c arranged in one line may be pushed toward the outer periphery and remain at displaced positions due to the centrifugal force generated by the rotation of the annular rotating body 20 or the influence of, for example, reaction of the drugs 5 that come into contact with the conveying surface guide 12 and the discharge guide 13.

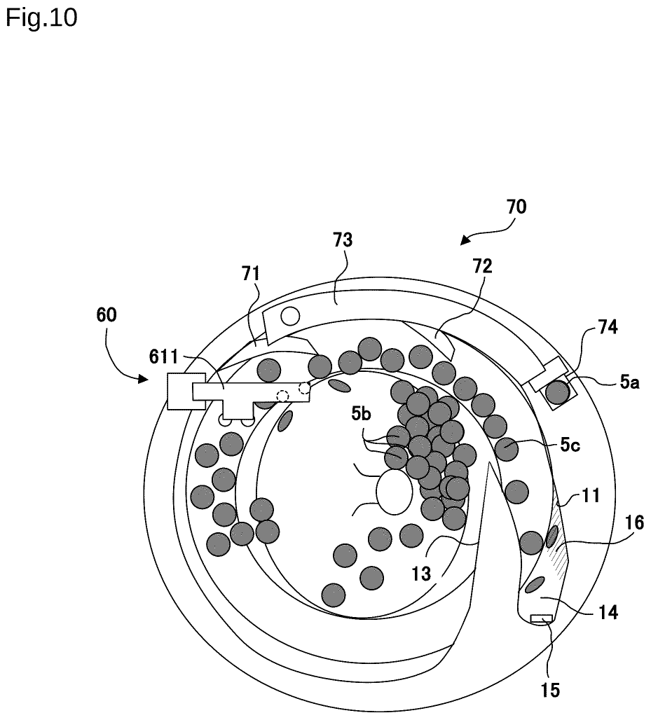

When such an irregular drug 5d is present, as illustrated in FIG. 10, there is a possibility that two drugs, that is, one aligned drug 5c and one irregular drug 5d, will be dropped simultaneously from the discharge port 14.

In addition, the irregular drug 5d in an outer peripheral region may move further outward when the aligned drugs 5c in an inner peripheral region are dropped, and unintentionally slide into a gap, such as a hollow gap 16 illustrated in FIG. 10, positioned on the outer peripheral side of the drug conveying path and inside the peripheral wall 11.

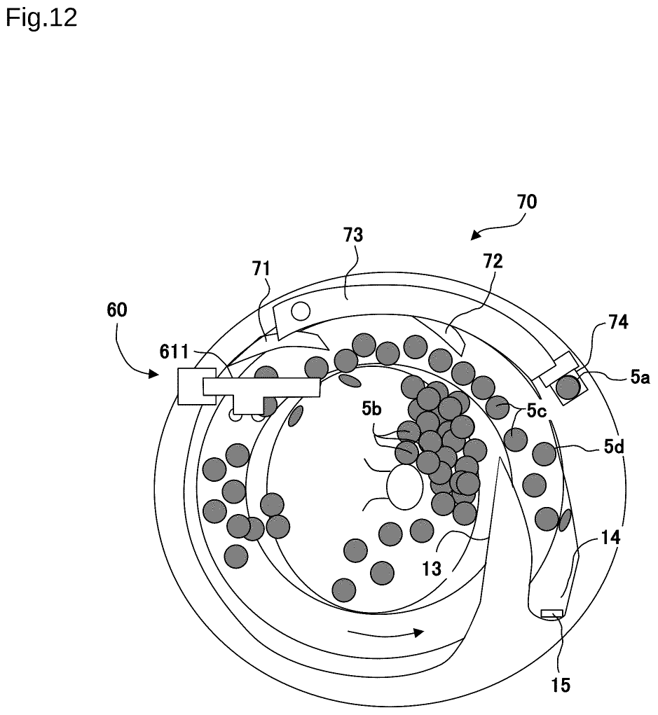

Normally, even when such unintended dropping of a drug occurs, the dropping of each drug is checked using the photosensor 15 as described above. Therefore, when the photosensor 15 detects the unintended dropping, as illustrated in FIG. 12, the rotation of the annular rotating body 20 can be reversed in direction or stopped to suspend dropping of the next drug.

However, when the annular rotating body 20 is rotated at a high speed, there is a possibility that the second drug will be dropped during the time from when the detection signal from the photosensor 15 is recognized by the controller to when the rotary drive motor 52 receives the signal and stops the annular rotating body 20. In addition, since the rotational speed is increased, the inertia of the drugs 5 at the time when the rotation is stopped may not be ignorable.

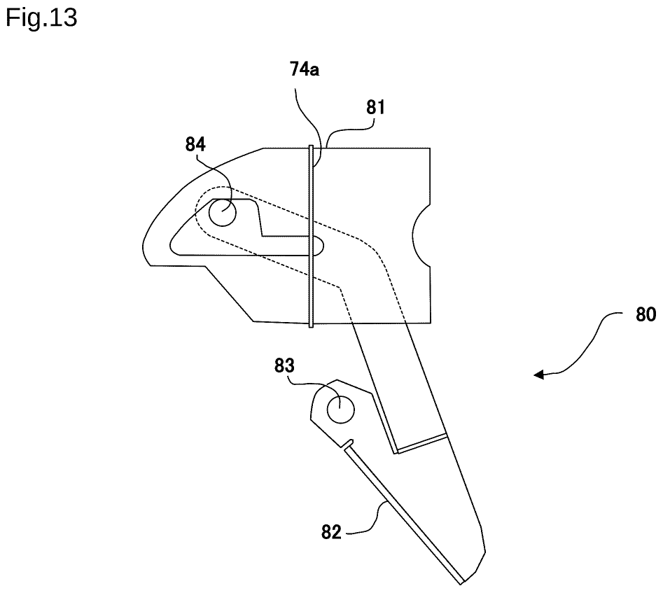

As described above, when the rotational speed of the annular rotating body 20 is increased, although the discharge rate of the drugs 5 can be increased, the stability of the operation of discharging the drugs 5 one at a time is degraded. To solve this technical problem, according to the present embodiment, a path extending member 80 is provided, as illustrated in FIGS. 13 to 15. The path extending member 80 is disposed such that at least a portion thereof projects from the peripheral wall 11, which is an outer side wall of the drug conveying path, in a direction toward the discharge guide 13, which is an inner side wall of the drug conveying path.

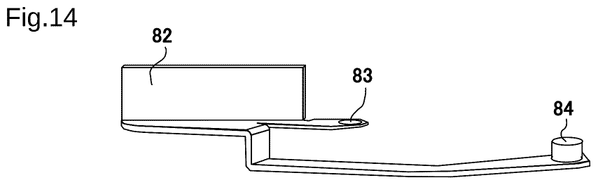

As illustrated in FIGS. 13 and 14, the path extending member 80 includes a projecting portion 84, a dimension measurement guide plate 81, a fulcrum shaft 83, and a drug contact portion 82. The dimension measurement guide plate 81 is engaged with the projecting portion 84 and regulates the range of movement of the projecting portion 84. The fulcrum shaft 83 is disposed at a position at which the top peripheral portion 23 of the annular rotating body 20 and the peripheral wall 11 are spaced apart, and supports the path extending member 80 in a rotatable manner. The drug contact portion 82 is positioned at an end opposite to the end at which the dimension measurement guide plate 81 is provided with the fulcrum shaft 83 disposed therebetween. The contact portion 82 operates in conjunction with the dimension measurement guide plate 81.

The dimension measurement guide plate 81 is fixed to the movable wall 74a of the model receiver 74 and operates together with the movable wall 74a. The dimension measurement guide plate 81 is a moving member that moves to a position corresponding to the dimension of the sample drug 5a placed on the model receiver 74 in response to the operation of the movable wall 74a.

As illustrated in FIG. 14, the projecting portion 84, the fulcrum shaft 83, and the drug contact portion 82 are formed of an integral member. The fulcrum shaft 83 is rotatably retained by the plate 120 that defines the peripheral wall 11.

The projecting portion 84 is engaged with an opening in the dimension measurement guide plate 81, and the position thereof is regulated by the opening in response to the operation of the movable wall 74a.

Therefore, the path extending member 80 is rotatable about the fulcrum shaft 83 in accordance with the position of engagement between the projecting portion 84 and the dimension measurement guide plate 81.

The drug contact portion 82 is a wall portion having a wall surface extending upward from the floor surface of the top peripheral portion 23 when the path extending member 80 is attached.

At least a portion of the drug contact portion 82 extends upward beyond the top peripheral portion 23. When the drug contact portion 82 is positioned to be in contact with the top peripheral portion 23, the drug contact portion 82 constitutes a side wall surface of the drug conveying path to operate as a width regulation portion that regulates the width of the drugs.

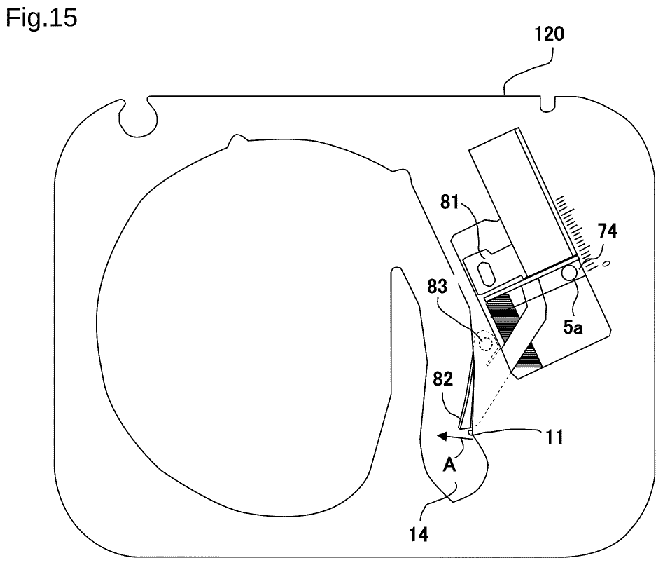

As illustrated in FIG. 15, the path extending member 80 is disposed along the top peripheral portion 23 of the annular rotating body 20 in the vicinity of the drop discharge port 14 and on the outer peripheral side of the annular rotating body 20.

In the present embodiment, a position in the “vicinity” of the drop discharge port 14 may be any position in a region extending downstream from the second regulating member 72 to the drop discharge port 14 along the conveying path. In addition, since the top peripheral portion 23 is an upper surface of the annular rotating body 20, to be disposed “along” the top peripheral portion 23 means to be at a position spaced from or near the arc of the circumferential top peripheral portion 23 by a predetermined design distance or less.

In the present embodiment, the drug contact portion 82, which is at least a portion of the path extending member 80, is disposed to project toward the inner periphery from the peripheral wall 11 to protrude over the hollow gap 16 between the peripheral wall 11 and the top peripheral portion 23. According to this structure, when the path extending member 80 rotates around the fulcrum shaft 83, the drug contact portion 82 can move in the direction shown by arrow A, that is, toward the top peripheral portion 23 at the inner periphery when viewed from above.

In other words, the path extending member 80 is rotatably retained by the fulcrum shaft 83 in the drug feeder 100, and rotate rightward or leftward when the projecting portion 84 or the dimension measurement guide plate 81 engaged with the projecting portion 84 move in accordance with the dimension of the sample drug 5a placed on the model receiver 74.

A spring 86 is connected to the path extending member 80 at a position closer to the dimension measurement guide plate 81 than the fulcrum shaft 83. The spring 86 serves as an urging member for urging the drug contact portion 82 in a direction to return the drug contact portion 82 to an initial position when, for example, the sample drug 5a is not placed on the model receiver 74. When the sample drug 5a is not placed on the model receiver 74, the spring 86 causes the drug contact portion 82 to be disposed at a position along and near the top peripheral portion 23 such that the drug contact portion 82 coincides with the arc of the top peripheral portion 23 as viewed from above. This position is the initial position.

When the sample drug 5a is disposed on the model receiver 74, as described below, the drug contact portion 82 is positioned in accordance with the dimension of the sample drug 5a so as to be separated from the outer peripheral side wall surface of the discharge guide 13 (inner wall surface of the drug conveying path) by a distance L corresponding to the dimension of the sample drug 5a.

The operations and effects of the path extending member 80 will now be described.

As described above, when the speed of the annular rotating body 20 is increased, some of the drugs 5 become the irregular drugs 5d instead of the aligned drugs 5c, and this degrades the stability of the discharging operation.

When the operator places the sample drug 5a on the model receiver 74, the dimension measurement guide plate 81 is also operated in conjunction with the movable wall 74a or the link mechanism 73, and moves to the position corresponding to the width of the sample drug 5a. Thus, the position of the dimension measurement guide plate 81 is set.

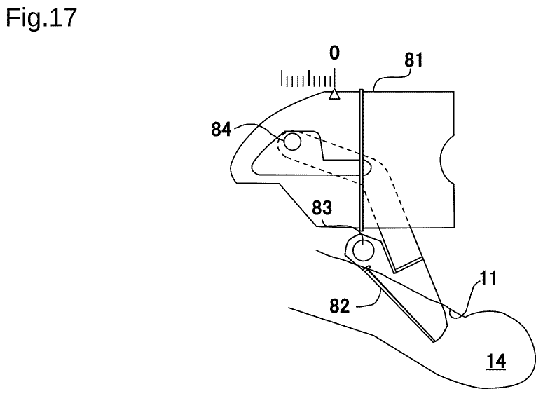

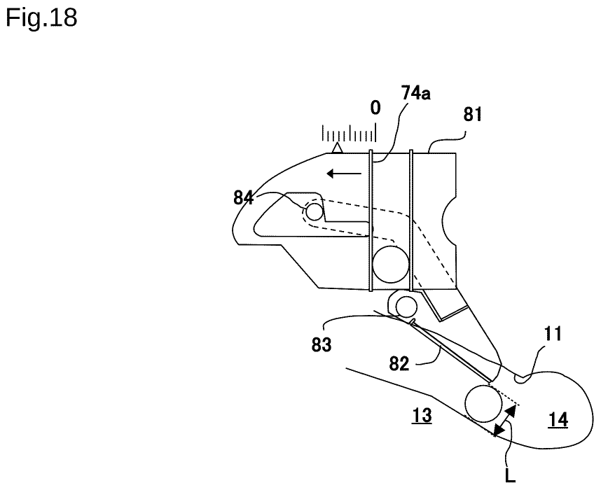

Referring to FIGS. 17 and 18, assume that, for example, the sample drug 5a, which is a φ7.5 circular tablet, is placed on the model receiver 74 in the initial state illustrated in FIG. 17. In this case, as illustrated in FIG. 18, the movable wall 74a moves to the position indicating 7.5 mm. At this time, the position at which the projecting portion 84 engages with the dimension measurement guide plate 81 changes in accordance with the position of the movable wall 74a, so that the position of the projecting portion 84 changes accordingly. The positional relationship between the fulcrum shaft 83 and the projecting portion 84, of course, does not change. Therefore, as illustrated in FIG. 18, when the position of the projecting portion 84 is determined, the path extending member 80 rotates about the fulcrum shaft 83, and the position of the drug contact portion 82 at the end opposite to the end of the projecting portion 84 is also determined. In the present embodiment, the design is such that when the 7.5-mm tablet is placed on the model receiver 74, the drug contact portion 82 is positioned at a distance of L=7.5 mm from the outer side surface of the discharge guide 13.

As described below, the drug contact portion 82 allows passage of the aligned drugs 5c and pushes each irregular drug 5d toward the inner periphery of the conveying path to prevent unintended dropping through the drop discharge port 14. Therefore, the distance L between the drug contact portion 82 and the discharge guide 13 of less than the width of the tablet placed on the model receiver 74 is not preferable because this may cause the aligned drugs 5c to clog the drop discharge port 14.

The tablets may simply be pushed toward the inner periphery to prevent the tablets from being dropped. Therefore, as long as the tablets are not dropped, the drug contact portion 82 may be spaced from the top peripheral portion 23 on the transport surface, and the distance L between the drug contact portion 82 and the discharge guide 13 may be set to any distance equal to or greater than the width of the tablet placed on the model receiver 74.

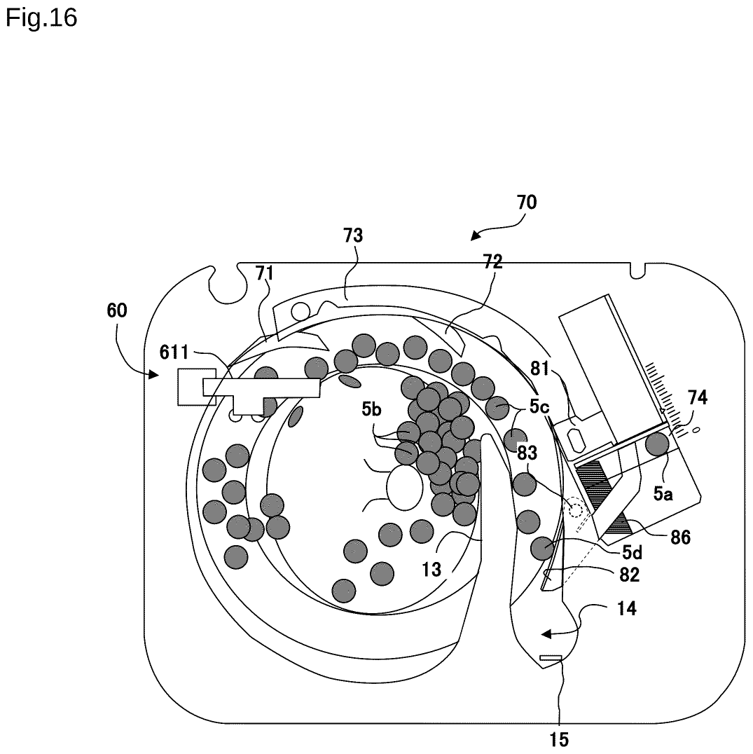

As illustrated in FIG. 16, the path extending member 80 according to the present embodiment includes the drug contact portion 82 positioned to block the hollow gap 16 between the peripheral wall 11 and the top peripheral portion 23. Therefore, even when the irregular drug 5d is present, the contact portion 82 comes into contact with the irregular drug 5d and pushes the irregular drug 5d toward the discharge guide 13, so that the irregular drug 5d can be treated as one of the aligned drugs 5c. Thus, the drugs 5 can be reliably conveyed to the drop discharge port 14.

According to the above-described structure, even when the speed of the annular rotating body 20 is increased, the drugs can be reliably discharged one at a time. Therefore, the successive discharge rate of the drug feeder 100 can be increased, and unintended dropping of the drugs can be prevented.

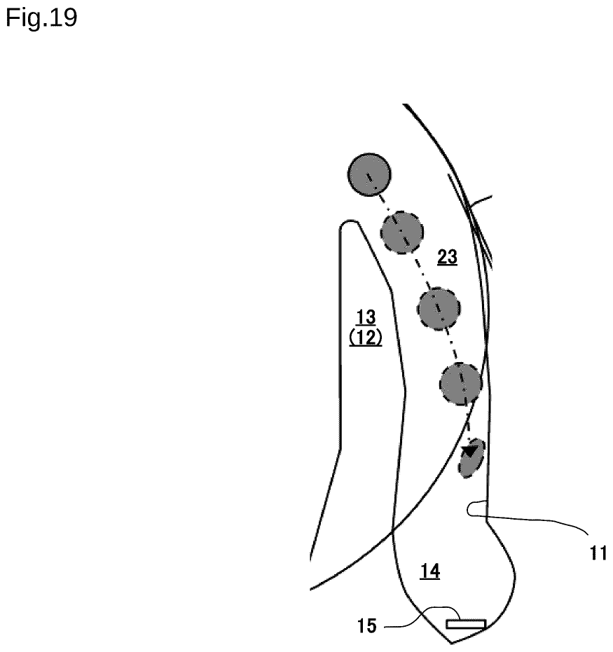

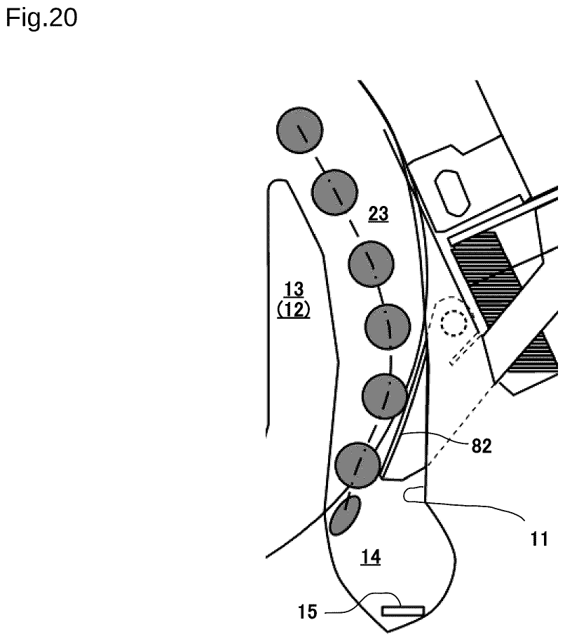

The effect of the path extending member 80 is to push the irregular drug 5d inward from the peripheral wall 11, which is the outer peripheral wall surface of the conveying path. Essentially, the effect is to prevent the conveying path along which the irregular drug 5d is conveyed before discharge from becoming shorter (because the irregular drug 5d is dropped before reaching the drop discharge port 14). More specifically, the path extending member 80 is characterized in that the conveying path that becomes shorter in the structure of the related art as illustrated in FIG. 19 is extended along the arc-shaped top peripheral portion 23, as schematically illustrated in FIG. 20.

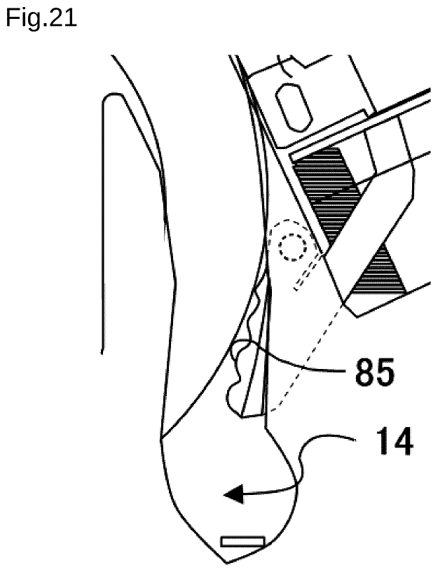

In other words, the object is to extend the conveying path, and the drug contact portion 82 may, for example, have a structure other than that illustrated in FIGS. 13 to 15, such as the structure of a reference example illustrated in FIG. 21, in which the drug contact portion 82 includes a side wall surface 85 having a meandering shape. The shape of the drug contact portion 82 is not limited to those described in the present embodiment.

In the present embodiment, the position of the path extending member 80 can be moved in accordance with the dimension of the sample drug 5a determined by the link mechanism 73 and the model receiver 74, which serve as the dimension measurement mechanism.

According to the above-described structure, even when the speed of the annular rotating body 20 is increased, the drugs can be reliably discharged one at a time. Therefore, the successive discharge rate of the drug feeder 100 can be increased, and unintended dropping of the drugs can be prevented.

The path extending member 80 is provided to prevent the irregular drug 5d from being unintentionally dropped from the outer periphery of the top peripheral portion 23 as illustrated in FIG. 10. Therefore the path extending member 80 may be spaced from the top peripheral portion 23.

More specifically, when viewed from above in the direction of the axis of rotation of the annular rotating body 20, the drug contact portion 82 may be disposed at any position between the peripheral wall 11 and the outer periphery of the top peripheral portion 23. At this time, when the drug contact portion 82 is positioned such that the dimension of the sample drug 5a on the model receiver 74 is greater than an interval L2 from the outer periphery of the top peripheral portion 23 to the drug contact portion 82 as viewed in the same direction, the irregular drug 5d does not fall through the hollow gap 16 because the dimension thereof is the same as that of the sample drug 5a.

Thus, the distance from the top peripheral portion 23 to the drug contact portion 82 may be determined based on the dimension of the sample drug 5a measured by the link mechanism 73 and the model receiver 74 that form the dimension measurement mechanism. In this case, the drug contact portion 82 prevents the irregular drug 5d from being unintentionally dropped in the outer peripheral region. Therefore, the drugs can be reliably discharged one at a time even when the speed of the annular rotating body 20 is increased.

In addition, according to the present embodiment, a surface of the drug contact portion 82 of the path extending member 80 that comes into contact with the drugs 5 has a curvature.

This shape can reduce the impact on the irregular drug 5d upon contact compared to when the drug contact portion 82 has a straight shape. Therefore, breakage and chipping of the irregular drug 5d can be prevented.

The drug feeder according to the present invention may be used to replace some or all of arrangement-disk-rotation type drug feeders mounted in a tablet packing machine. Alternatively, the drug feeder according to the present invention may be mounted in, for example, a tablet splitter including one or a small number of drug feeders, or a tablet counter (drug counter) for counting the number of drugs successively fed in a device for filling drug bottles with drugs, such as tablets.

In addition, in the present embodiment, the drug contact portion 82 operates in conjunction with the operation of the movable wall 74a of the model receiver 74. However, the drug contact portion 82 is not limited to this, and may be independently driven with a motor or the like to project from the peripheral wall 11 by an appropriate distance.

### REFERENCE SIGNS LIST

5, 5a, 5b, 5c, 5d drug
11 peripheral wall, 11a inner peripheral wall surface (inner wall surface of hollow opening in peripheral wall),
12 conveying surface guide, 13 discharge guide, 14 drop discharge port, 15 photosensor (drug drop detection means),
20 annular rotating body, 23 top peripheral portion (drug conveying path),
30 inclined rotating body, 31 central projection, 32 central portion, 33 peripheral portion,
20+30 rotating container,
40 support mechanism, 41 bearing member,
42, 43 rotation transmission member,
50 rotary drive mechanism, 51 rotary drive member,
52, 53 rotary drive motor,
60 sorting member, 611 support member, 610 first sorting member, 620 second sorting member,
70 regulation mechanism, 71 first regulating member, 72 second regulating member, 73 link mechanism, 74 model receiver, 74a movable wall,
80 path extending member, 81 dimension measurement guide plate, 82 drug contact portion, 83 fulcrum shaft, 84 projecting portion, 85 side wall surface, 86 spring,
100 drug feeder, 120 upper member (plate)

1. A drug feeder comprising:
an annular rotating body rotatable about a first axis of rotation;
an inclined rotating body rotatable about a second axis of rotation inclined relative to the first axis of rotation, the inclined rotating body being disposed inside the annular rotating body;
a sorting member and a regulating member that align solid drugs when the annular rotating body rotates, the drugs being carried to a top peripheral portion of the annular rotating body by rotation of the inclined rotating body; and
drug drop detection means that detects the drugs carried to a drop discharge port by the annular rotating body and dropped,
wherein the sorting member is disposed to regulate a height for the drugs on the top peripheral portion of the annular rotating body,
wherein the regulating member regulates a lateral width of a drug conveying path on the top peripheral portion of the annular rotating body,
wherein the drug feeder further comprises a path extending member capable of being disposed along the top peripheral portion of the annular rotating body in a vicinity of the drop discharge port and on an outer peripheral side of the annular rotating body, thereby defining a side wall of the drug conveying path, and
wherein the path extending member serves to extend the drug conveying path.

2. The drug feeder according to claim 1, further comprising:
a dimension measurement mechanism that measures a dimension of the drugs at a predetermined position,
wherein the path extending member is movable in accordance with the dimension of the drugs obtained by the dimension measurement mechanism.

3. The drug feeder according to claim 2, further comprising:
an upper member attached to an upper portion of the annular rotating body and positioned to extend across the top peripheral portion to define an inner side wall and an outer side wall of the drug conveying path,
wherein the path extending member includes a fulcrum shaft at a position at which the top peripheral portion of the annular rotating body and the outer side wall are spaced apart, and
wherein at least a portion of the path extending member is positioned at a hollow gap between the outer side wall and the top peripheral portion.

4. The drug feeder according to claim 3,
wherein one end portion of the path extending member is positioned at the hollow gap, and another end portion of the path extending member that is opposite to the one end portion with the fulcrum shaft disposed therebetween is connected to the dimension measurement mechanism, and
wherein the path extending member is supported such that the path extending member is rotatable about the fulcrum shaft in response to an operation of the dimension measurement mechanism.

5. The drug feeder according to claim 2,
wherein the path extending member is positioned such that the dimension of the drugs determined by the dimension measurement mechanism is greater than an interval between the path extending member and the top peripheral portion of the annular rotating body.

6. The drug feeder according to claim 1,
wherein a surface of the path extending member that comes into contact with the drugs has a curvature.

7. A tablet packing machine comprising:
the drug feeder according to claim 1; and
a packing machine that packs the drugs discharged from the drop discharge port of the drug feeder.

8. The drug feeder according to claim 3,
wherein the path extending member is positioned such that the dimension of the drugs determined by the dimension measurement mechanism is greater than an interval between the path extending member and the top peripheral portion of the annular rotating body.

9. The drug feeder according to claim 4,
wherein the path extending member is positioned such that the dimension of the drugs determined by the dimension measurement mechanism is greater than an interval between the path extending member and the top peripheral portion of the annular rotating body.

10. The drug feeder according to claim 2,
wherein a surface of the path extending member that comes into contact with the drugs has a curvature.

11. The drug feeder according to claim 3,
wherein a surface of the path extending member that comes into contact with the drugs has a curvature.

12. The drug feeder according to claim 4,
wherein a surface of the path extending member that comes into contact with the drugs has a curvature.

13. The drug feeder according to claim 5,
wherein a surface of the path extending member that comes into contact with the drugs has a curvature.

14. A tablet packing machine comprising:
the drug feeder according to claim 2; and
a packing machine that packs the drugs discharged from the drop discharge port of the drug feeder.

15. A tablet packing machine comprising:
the drug feeder according to claim 3; and
a packing machine that packs the drugs discharged from the drop discharge port of the drug feeder.

16. A tablet packing machine comprising:
the drug feeder according to claim 4; and
a packing machine that packs the drugs discharged from the drop discharge port of the drug feeder.

17. A tablet packing machine comprising:
the drug feeder according to claim 5; and
a packing machine that packs the drugs discharged from the drop discharge port of the drug feeder.

18. A tablet packing machine comprising:
the drug feeder according to claim 6; and
a packing machine that packs the drugs discharged from the drop discharge port of the drug feeder.
